(19) United States
(12) Patent Application Publication
(10) Pub. No.: US 2015/0088287 A1
(43) Pub. Date: Mar. 26, 2015

(54) DEVICE-OPERATION MANAGEMENT APPARATUS, REMOTE OPERATION SYSTEM, METHOD OF CONTROLLING DEVICE-OPERATION MANAGEMENT APPARATUS, AND STORAGE MEDIUM

(71) Applicant: SHARP KABUSHIKI KAISHA, Osaka (JP)

(72) Inventors: Takayuki NAGAMATSU, Osaka (JP); Kazuyuki NAKO, Osaka (JP); Masaki HASHIURA, Osaka (JP)

(73) Assignee: SHARP KABUSHIKI KAISHA, Osaka (JP)

(21) Appl. No.: 14/224,635

(22) Filed: Mar. 25, 2014

(30) Foreign Application Priority Data
Sep. 25, 2013 (JP) 2013-198795

(51) Int. Cl. H04L 12/28

(52) U.S. Cl. CPC H04L 12/282
USPC 700/90

(57) ABSTRACT

A device-operation management apparatus of the present invention is an agent server for receiving a device operation instruction from a portable terminal via a user's input operation and managing an operation of a house device, and causes an operation button to be displayed on the user's portable terminal so that the user can perform a touch operation, which operation button is for transmitting, to the device, the operation instruction for operating the device in accordance with an operation proposal included in a message which indicates the operation proposal to the home device.

This Nonprovisional application claims priority under 35 U.S.C. §119 on Patent Application No. 2013-198795 filed in Japan on Sep. 25, 2013, the entire contents of which are hereby incorporated by reference.

### TECHNICAL FIELD

The present invention relates to a device-operation management apparatus for managing operations of devices, a remote operation system, a method of controlling the device-operation management apparatus, and a storage medium.

### BACKGROUND ART

Recently, home electrical appliances (hereinafter, referred to as “home appliances”) have been widely spread, and various home appliances surround human life. Those home appliances are operated entirely by a user at present. For example, a user turns on/off a switch of a television and changes a preset temperature of an air conditioner by operating a remote control of each home appliance.

In this case, sensor information (e.g., room temperature information and humidity information) generated by sensors provided in respective home appliances etc. and operation information on home appliances generated by the respective home appliances need to be collected directly by a user from the sensors. Further, a user himself/herself also needs to collect external information (e.g., environment information such as weather forecast) needed for operating home appliances.

For example, Patent Literature 1 discloses an electronic communication device for supporting electronic communication between a user and a personified agent by obtaining external environment information via a network and outputting a generated sentence including the external environment information. By using the electronic communication device, a user himself/herself does not need to collect external information.

### CITATION LIST

### Patent Literature

Patent Literature 1

Japanese Patent Application Publication, Tokukai, No. 2005-92540 A (Publication date: Apr. 7, 2005)

### SUMMARY OF INVENTION

### Technical Problem

A user himself/herself does not need to collect external information by using the conventional art as described above. However, in a case where an operation instruction is transmitted to a home appliance on the basis of the external information, the user needs to search out a command for operation and to transmit the command.

For example, there is no particular problem if a user can transmit only one command that a home appliance can perform, however, in a case where the home appliance can perform various kinds of operations, it is necessary to search out a command for an intended operation from various commands and to transmit the command. This takes much time and effort.

Further, in a case where various home appliances can be operated by a single remote control, it takes much time and effort to search out a command for a target home appliance.

The present invention has been made in view of the above problems, and an object of the present invention is to provide a device-operation management apparatus etc. with which, in a case where a user transmits an operation instruction (command) to a target home appliance, the user does not need to search out the command.

### Solution to Problem

In order to achieve the above object, a device-operation management apparatus according to one aspect of the present invention, which is for receiving an operation instruction of a device from a terminal device via an input operation by a user and managing the operation of the device provided in a house, the device-operation management apparatus includes message composing means for composing a message indicating an operation proposal to the device provided in the house, wherein an operation setting used when a message whose content is the operation instruction for operating the device in accordance with the operation proposal indicated by the message composed by the message composing means is set in input means for receiving the input operation by the user from the terminal device.

A method of controlling a device-operation management apparatus according to one aspect of the present invention, which is for receiving an operation instruction of a device from a terminal device via an input operation by a user and managing the operation of the device provided in a house, the method includes the steps of: (A) composing a message indicating an operation proposal to the device provided in the house; and (B) setting, in input means for receiving the input operation by the user from the terminal device, an operation setting used when a message whose content is the operation instruction for operating the device in accordance with the operation proposal indicated by the message composed in the step (A).

### Advantageous Effects of Invention

According to one aspect of the present invention, a user does not need to search out an operation instruction (command) in a case where the user transmits the command to a target home appliance. Therefore, in a case where the user transmits the command to operate the home appliance, the present invention can reduce time and effort for the user.

### BRIEF DESCRIPTION OF DRAWINGS

FIG. 1 is a block diagram illustrating a main configuration of an agent server and a family message-board server according to one embodiment of the present invention.

FIG. 2 is a schematic view illustrating a family message-board system.

FIG. 3 is a view showing a specific example of a message list table stored in a storage section of the agent server illustrated in FIG. 1.

FIG. 4 is a view showing a specific example of a command seal list table stored in the storage section of the agent server illustrated in FIG. 1.

(a) to (c) of FIG. 5 show examples of time-line display of a flow of posting of a command seal according to Embodiment 1 of the present invention.

(a) to (c) of FIG. 6 show examples of time-line display of a flow of posting of a command seal according to Embodiment 2 of the present invention.

(a) to (c) of FIG. 7 show examples of time-line display of a flow of posting of a command seal according to Embodiment 3 of the present invention.

(a) to (c) of FIG. 8 show examples of time-line display of a flow of posting of a command seal according to Embodiment 4 of the present invention.

FIG. 9 is a specific example showing a message list table for use in the flow of the posting of the command seal illustrated in FIG. 8.

(a) to (c) of FIG. 10 show examples of time-line display of a flow of posting of a command seal according to Embodiment 5 of the present invention.

(a) to (c) of FIG. 11 show examples of time-line display of a flow of posting of a command seal according to Embodiment 6 of the present invention.

(a) of FIG. 12 is a view illustrating a message composing screen, (b) of FIG. 12 is a view showing a list table of commands embedded in operation buttons which are made with use of the message composing screen of (a) of FIG. 12.

(a) to (d) of FIG. 13 show examples of time-line display of a flow of posting of a command seal according to Embodiment 7 of the present invention.

FIG. 14 is a view showing a table for achieving button invalidation for use in the flow of the posting of the command seal illustrated in FIG. 13.

(a) to (c) of FIG. 15 show examples of time-line display of a flow of posting of a command seal according to Embodiment 8 of the present invention, (d) of FIG. 15 is a view illustrating an example of a check dialog displayed after (b) of FIG. 15, and (e) of FIG. 15 is an example of displaying a family message board on a television screen.

### DESCRIPTION OF EMBODIMENTS

The following embodiments will discuss an example where a device-operation management apparatus of the present invention is applied to a remote operation system. Note that, as an example, the remote operation system is achieved by a family message-board system.

That is, the family message-board system includes: a device-operation management apparatus of the present invention; and a message board device for managing an electronic message board which can be used by at least one terminal device, wherein: in a case where a message is posted on the electronic message board via the terminal device, the message board device notifies an instruction of a device to the device-operation management apparatus, which instruction is associated with the message thus posted; and the device-operation management apparatus transmits a command to the device to be instructed so as to cause the device to execute a function operation thus notified.

Note that, in the drawings used to describe the following embodiments, identical members or members having the like functions are denoted by the like symbols and the description thereof will not be discussed repeatedly. Further, for the sake of clarification and simplification of the drawings, dimensions such as a length, a size, a width, etc. and shapes in the drawings are changed as appropriate, so that those dimensions and shapes are not actual ones.

### Embodiment 1

The following description will discuss embodiments of the present invention in detail.

(Outline of Family Message-Board System)

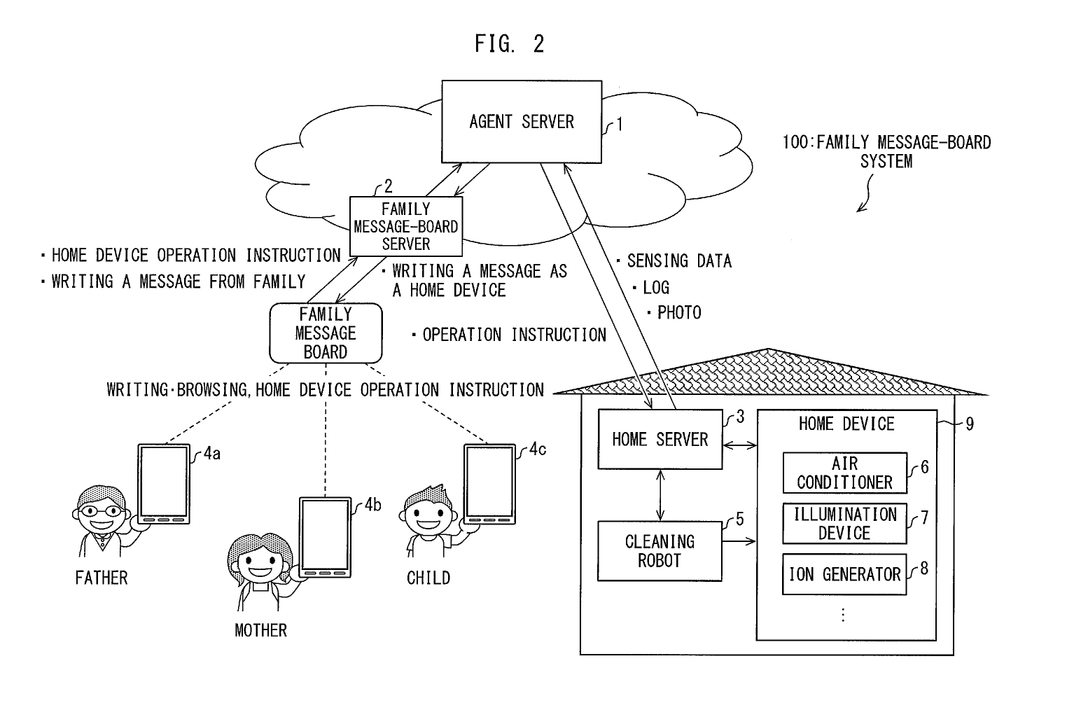

The following description will discuss outline of a family message-board system according to an embodiment of the present invention with reference to FIG. 2. FIG. 2 is a schematic view illustrating a family message-board system 100.

As illustrated in FIG. 2, the family message-board system 100 includes an agent server (device-operation management apparatus) 1, a family message-board server (message board device) 2, and a home server 3. A remote operation system of the present invention includes the servers configuring the family message-board system 100, portable terminals 4 (portable terminals 4a, 4b, 4c, etc.) which are connected to communicate with each of the servers, and remotely-operated devices (cleaning robot 5 and home device 9) which are remotely operated by the portable terminal 4.

The family message-board system 100 is a system in which one family forms one community via a family message board (electronic message board) provided by the family message-board server 2 and members (e.g., Father, Mother, Child, etc. Hereinafter, referred to as “user”) of the family post comments with use of their own mobile terminals 4. In this embodiment, when a user posts a comment (corresponding to “home device operation instruction” of FIG. 2) to operate the home device 9 on the family message board, it is possible to cause a remotely-operated device to execute a predetermined function in accordance with the comment. That is, the family message-board system functions as an user interface (UI) with which a user (each family member) remotely operates the home device 9.

More specifically, the portable terminals 4a, 4b, and 4c possessed by the users (Father, Mother, and Child in FIG. 2) access the family message board, and the users can write and brows comments via the family message board with use of their portable terminals. Particularly, in this embodiment, a user can easily transmit a home device operation instruction to the family message-board server 2 by selecting, on the portable terminal 4, an image which has been associated with a function of the home device 9 in advance and posting a comment including the image.

It is assumed that the portable terminal 4 is a so-called smartphone providing, on a display screen thereof, a touch screen which functions as a user interface for receiving a touch operation from a user.

The following description will be discussed by using the term “command seal” as the image associated with the function of the device. The term “command seal” used herein does not exclude the above various images. A method of remotely operating a device with use of a command seal will be described below with specific examples.

When the family message-board server 2 receives a comment including the command seal, a function associated with the command seal is notified to the agent server 1. The agent server 1 achieves a remote operation by communicating with the home server 3 to instruct the device to execute the function.

Note that the family message-board system 100 may function as a communication tool between/among users, so that the users have conversation between/among the users via the family message board by posting a comment to other users.

The device-operation management apparatus of the present invention is achieved as the agent server 1 in the above family message-board system 100. The agent server 1 is a device which supply, to the home device 9 working in a house of the family, a command (corresponding to “operation instruction” of FIG. 2) to cause the home device 9 to execute a function instructed on the basis of content of a home device operation instruction posted on the family message board. Note that the agent server 1 includes a comment posting section (not shown). The comment posting section applies a pseudo-personality, as a member of the family, to the home device 9 working in the house, and can post a comment on the family message board of the family instead of the personified home device (hereinafter, “personified device”) 9.

For each community (family) which uses a service of the family message board, the agent server 1 retains information on a room arrangement of the house of the family and on the home device 9 placed in the house. Further, the agent server 1 retains a list of various functions of the home device 9, and can present, to the user's portable terminal 4, which function can be called by the remote operation. The agent server 1 has a function of converting the home device operation instruction transmitted from the user's portable terminal 4 via the family message board to a command sequence (operation instruction of FIG. 2) that the home server 3 or the home device 9 can understand. This conversion is executed in accordance with the room arrangement of the house where the user lives.

The family message-board server 2 performs general processes regarding the family message board, such as presentation of a display screen of the family message board to the portable terminals 4a, 4b, and 4c, presentation of a command seal associated with a function that can be called, and management of posting of comments. Among all functions managed by the agent server 1, the family message-board server 2 retains a function that can be called by each user who uses the family message board while associating the function with the command seal.

The home server 3 unifies and controls transmission and reception of information between the cleaning robot 5 or the home device 9 and the agent server 1. Specifically, the home server 3 analyzes an operation instruction that has been received from the agent server 1, and controls operations of the cleaning robot 5 or the home device 9 in accordance with operation instructions. Further, the home server 3 transmits, to the agent server 1, information that has been obtained from the cleaning robot 5 and information that has been obtained from the home device 9. Here, the information that has been obtained from the cleaning robot 5 and is transmitted to the agent server 1 has sensor information generated by a sensor placed in the house. The information that has been obtained from the home device 9 has operation information on the device which the home device 9 has generated.

Here, the sensor information is environment information such as a room temperature, humidity, illuminance, etc. of a place where the home device 9 is provided. The operation information is information showing a state of the home device 9 (e.g., on/off of a power source of the device, a preset temperature and preset humidity in a case where the device is the air conditioner 6, illuminance in a case where the device is an illumination device 7).

The home server 3 is connected to the cleaning robot 5 via a wireless communication network, and the home device 9 are connected via a wireless or wired communication network. Note that, in this embodiment, the cleaning robot 5 is distinguished from the other home devices 9, and the cleaning robot 5 is configured to control the home device directly. As the home device 9 controlled by the cleaning robot 5, the air conditioner 6, the illumination device 7, and an ion generator 8 are illustrated in FIG. 2, however, the type and the number of the home devices are not particularly limited. In addition to them, the home device 9 may encompass various home appliances such as television, recording device, speaker, refrigerator, microwave, air cleaner, humidifier, and electric fan.

Note that, in a case where, other than the cleaning robot 5, there is no device that the agent server 1 can remotely operate in the house, i.e., in a case where there is no need to control entire home devices, the cleaning robot 5 may be arranged to transmit/receive information directly to/from the agent server 1 without providing the home server 3.

The portable terminals 4a, 4b, and 4c are devices for browsing the family message board, for posting comments on the family message board, and, particularly, for transmitting operation instructions to the cleaning robot 5 or other home devices. FIG. 2 shows an example where the portable terminals 4a, 4b, and 4c are smartphones, however, the portable terminals are not limited thereto provided that they can be used for browsing the family message board, posting comments on the family message board, and transmitting operation instructions. In a case where there is no particular need to identify the portable terminals 4a, 4b, and 4c, they are generally called as “portable terminal 4”.

The cleaning robot 5 is a self-propelled vacuum cleaner which automatically cleans floors. The cleaning robot 5 has a function of transmitting control signals to the home device 9 (air conditioner 6, illumination device 7, and ion generator 8 described below) and operating the home device 9. As a mechanism for transmitting control signals, an appropriate short-range radio communication mechanism, such as infrared radiation and Bluetooth (registered trademark), is employed. Further, the cleaning robot 5 has not only the above function but also a function of storing operation logs, a function of detecting and outputting remaining battery charge, an image photographing function, a voice recognizing function, a voice outputting function, and the like.

The air conditioner 6 is a device for performing air-conditioning such as heating, cooling, and dehumidification, i.e., so-called air conditioner. The illumination device 7 includes a light source such as LEDs and has a function of adjusting brightness, color, etc. Specifically, in this embodiment, the illumination device 7 has a function of full-lightning (turning on the light at a brightness of 100%), a function of lightning (turning on the light at a predetermined brightness which was a brightness immediately before the light was previously turned off), a function of all-night light (turning on the light at a brightness for all-night light and having a color for all-night light), a function of Yaezakura (which means “double cherry blossom”) (turning on the light having a particular color), a function of Someiyoshino (which means “Yoshino cherry”) (turning on the light having a particular color), and a function of lights-out. The ion generator 8 is a blowing device having a function of generating ions and supplying air containing ions inside a room.

As described above, in the family message-board system 100, the agent server 1 presents functions of performing a remote operation to a user via the family message-board server, receives a function determined by the user, and controls the home device to execute the function.

Further, as a device-operation management apparatus of the present invention, the agent server 1 analyzes the environment information obtained from the home server 3 and the operation information on devices of the home devices 9, and presents a message in accordance with a result of this analysis to the portable terminal 4 that the user operates. Further, in a case where the user replies to the message presented to the portable terminal 4, the agent server 1 has a function of automatically selecting a command to the device in response to this reply and managing an operation of the cleaning robot 5 or the home device 9 via the home server 3. Note that detailed configuration of the agent server 1 will be described below.

(Configuration of Each Server)

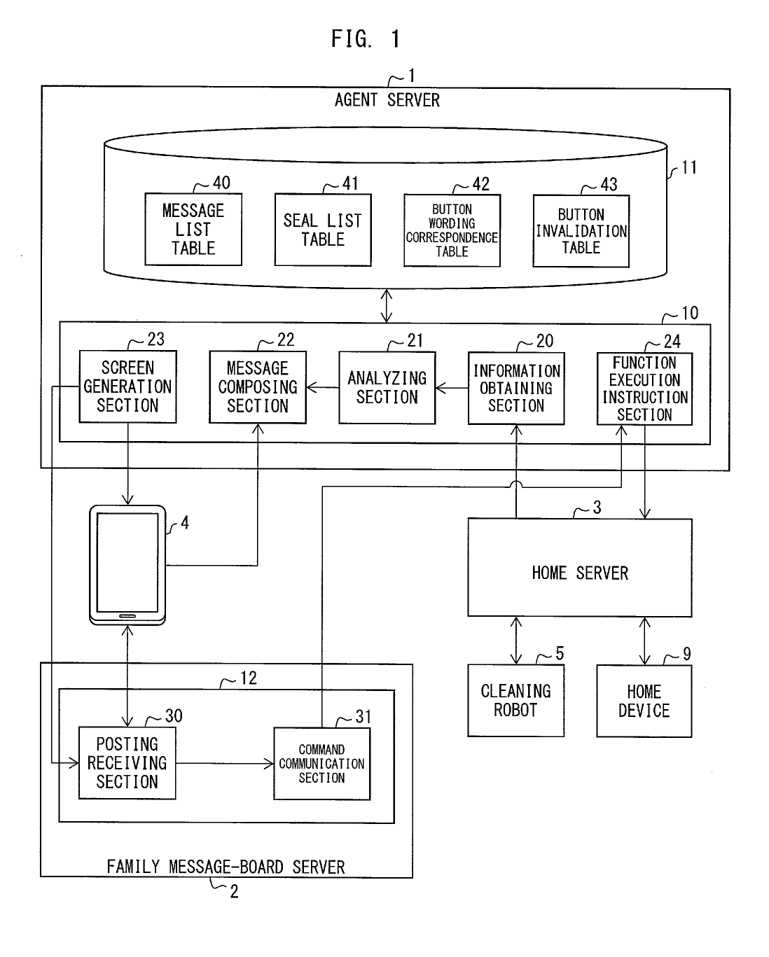

FIG. 1 is a block diagram illustrating a main configuration of the agent server 1 and the family message-board server 2.

As illustrated in FIG. 1, the agent server 1 of this embodiment includes a control section 10 and a storage section 11, and the family message-board server 2 includes a control section 12. Each of the servers includes a communication section (not shown). Further, each server may include a display section and an input section (not shown) which are used to be operated by an operator of each server.

The each communication section (not shown) is a section for communicating with an external device via a communication network. The agent server 1, the family message-board server 2, the home server 3, and the portable terminal 4 can be connected with one another by the each communication section via the Internet and can transmit/receive data.

The storage section 11 is for non-transitorily storing a controlling program, an OS program, an application program, and various data which are read out when the application program is carried out. For example, the storage section is achieved by storage devices such as ROM (read only memory), flash memory, EPROM (Erasable Programmable ROM), EEPROM (registered trademark) (Electrically EPROM), HDD (Hard Disc Drive), etc.

The control section 10 and the control section 12 unify and control sections included in the agent server 1 and sections included in the family message-board server 2, respectively.

The control section 10 of the agent server 1 of this embodiment includes, as function blocks, at least an information obtaining section (information obtaining means) 20, an analyzing section 21, a message composing section (message composing means) 22, a screen generation section (display control means) 23, and a function execution instruction section 24. The control section 12 of the family message-board server 2 includes, as function blocks, at least a posting receiving section 30 and a command communication section 31. The function blocks of each of the control sections described above can be achieved by, for example, causing a CPU (central processing unit) or the like to read out a program stored in a storage section achieved by a ROM (read only memory), an NVRAM (non-Volatile random access memory), or the like to a RAM (random access memory) (not shown) or the like and executing the program.

(Function Configuration of Agent Server)

The information obtaining section 20 of the control section 10 is configured to obtain the sensor information (environment information) generated by the sensor provided in the house and the operation information on the device provided in the house, which is generated by the device.

Specifically, the information obtaining section 20 obtains, from the home server 3, the environment information in the house and the operation information on the home device 9, which is generated by the home device 9. Here, the environment information is information indicating a temperature, humidity, illuminance, etc. of a place where the home device 9 is provided as described above. The sensor for sensing the environment information may be provided in the house, or may be provided in the cleaning robot 5. Further, the operation information on the device means information indicating a state of the device. For example, in a case where the device is the air conditioner 6 as described above, the operation information is information on a state of on/off of a power source of the device and information on a preset temperature and a preset humidity when the power source is on, meanwhile, in a case where the device is the illumination device 7, the operation information is information on on/off of a power source of the device and information on a state of lightning when the power source is on, and, in a case where the device is the ion generator 8, the operation information is information on a state of on/off of a power source of the device and information on an ion generation amount when the power source is on.

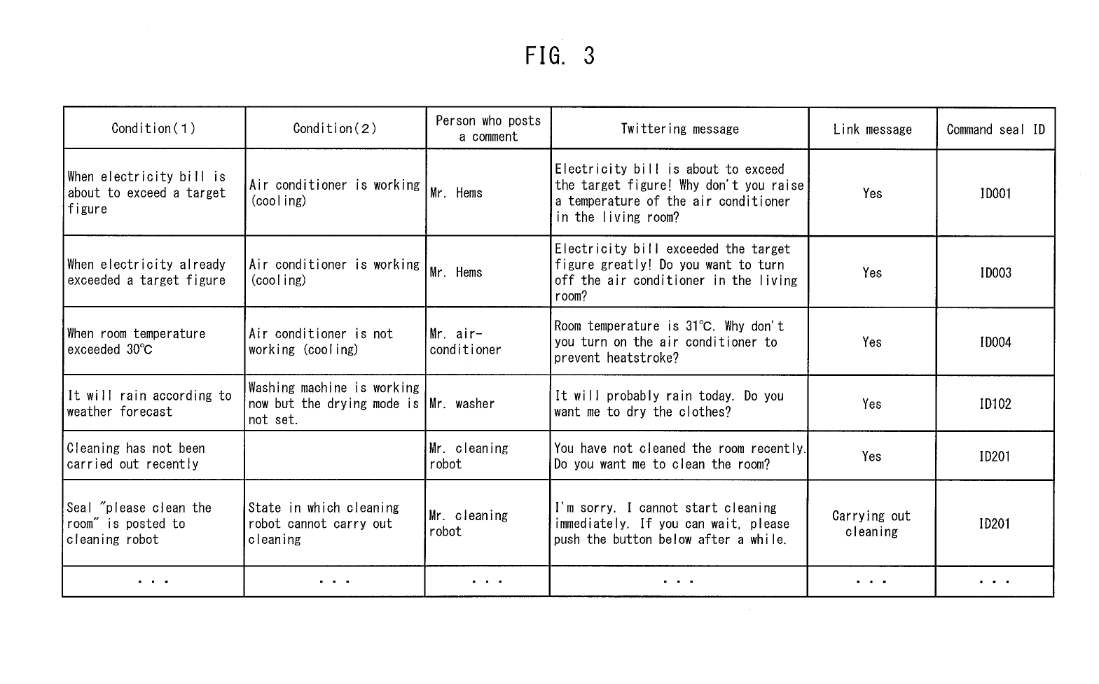

The analyzing section 21 of the control section 10 analyzes at least one of the sensor information and the operation information on the device, which are obtained by the information obtaining section 20. Specifically, the analyzing section 21 analyzes at least one of (i) the environment information (this environment information may be sensor information sensed by the cleaning robot 5) from the sensor provided in the house and (ii) the operation information on the home device 9, which is generated by the home device 9. A result of this analysis shows a result of specifying, on the basis of the information thus obtained, conditions (1) and (2) shown in a message list table 40 of FIG. 3 (described below) and a person who posted a comment. That is, the analysis of the analyzing section 21 is to identify (i) who posts a comment (Mr. Hems (personified home server 3), Mr. air-conditioner (personified air conditioner 6), Mr. washer (personified washing machine), Mr. cleaning robot (personified cleaning robot 5), or other devices) and (ii) in what state the device managed by the personified device is (condition (1), condition (2)).

Note that the analysis of the analyzing section 21 only needs to use at least one of the sensor information and the operation information. Therefore, the information obtaining section 20 only needs to obtain at least one of the sensor information and the operation information.

The message composing section 22 of the control section 10 composes a message in accordance with the result of the analysis of the analyzing section 21. Specifically, on the basis of the analysis result thus obtained, the message composing section 22 refers to the message list table 40 of FIG. 3 (described below) and extracts a twittering message etc. posted by a person who posted a comment. This message includes a proposal, a recommendation, or a suggestion to the user who operates the portable terminal 4.

The screen generation section 23 of the control section 10 receives the message etc. extracted by the message composing section 22, generates a screen as illustrated in, for example, (a) of FIG. 5, and transmits the screen to the family message-board server 2. That is, the screen generation section 23 transmits, to the family message-board server 2, (i) an operation button (a reference symbol 52 illustrated in (a) of FIG. 5) for writing information for use in operation of the device in accordance with an operation proposal indicated by the message composed by the message composing section 22 and (ii) display data displayed on the portable terminal 4 so that a touch operation can be performed. The display data thus transmitted is written on the family message board by the family message-board server 2, and a posting screen on which the operation button 52 is displayed so that a touch operation can be performed by the user.

The operation button 52 is means for performing an operation setting used when a message whose content is an operation instruction for operating the device in accordance with the operation proposal indicated by the message composed by the message composing section 22 is composed and is set in input means (touch screen, physical key) for receiving an input operation by the user from the portable terminal 4. This embodiment and other embodiments (described below) will discuss an example where the operation button 52 is displayed on the touch screen of the portable terminal 4 so that a touch operation can be performed. However, the present invention is not limited thereto, and a physical key (numeric key etc.) that the portable terminal 4 includes may be set as the operation button 52. In this case, information indicating which key is set as the operation button 52 needs to be displayed on the display screen of the portable terminal 4.

Further, the screen generation section 23 is also configured to generate a screen for presenting, to the user, the result of the analysis performed in the analyzing section and to transmit the result directly to the portable terminal 4. The above configuration is to allow a user to directly perform, with use of the portable terminal 4, a remote operation on the home device 9 which is managed by the home server 3, without the family message-board server 2.

The function execution instruction section 24 of the control section 10 obtains the command from the family message-board server 2 and, in response to the command thus obtained, transmits the function execution instruction to the home server 3.

The function execution instruction section 24 can directly obtain the command indicating the operation instruction from the portable terminal 4, and, also in this case, similarly, the function execution instruction section 24 transmits the function execution instruction of the device to the home server 3 on the basis of the command thus obtained.

The agent server 1 includes not only the control section 10 but also the storage section 11 as described above. The storage section 11 includes at least the message list table 40, a seal list table 41, a button wording correspondence table 42, and a button invalidation table 43. Note that, in this embodiment, the message list table 40 and the seal list table 41 will be discussed, and the button wording correspondence table 42 and the button invalidation table 43 will be described in another embodiment described below.

(Message List Table)

FIG. 3 is a view showing a specific example of the message list table 40 stored in the storage section 11. Note that the message list is shown in the form of a table data structure in FIG. 3, which is merely an example, and FIG. 3 does not limit the data structure of the function list. Hereinafter, the same applies to other drawings showing data structures.

In the message list table 40, pairs of conditions (1) and (2), persons who posted a comment, twittering messages, link messages, and command seal IDs are stored while being associated with one another. For example, in a case where, as the condition (1), the result of the analysis of the analyzing section 21 exceeds a target electricity bill and, as the condition (2), the air conditioner (cooling) is being operated, the message composing section 22 extracts Mr. Hems as a person who posted a comment and a message that “Electricity bill is about to exceed the target figure! Why don't you raise a temperature of the air conditioner in the living room?” as a twittering message. Note that those are merely examples.

As described above, the message composing section 22 extracts, from the message list table 40, a twittering message associated with the conditions (1) and (2) which are the result of the analysis of the analyzing section 21 and a person who posted a comment, a link message, and a command seal ID, and supplies the twittering message, the link message, and the command seal ID to the screen generation section 23.

(Seal List Table)

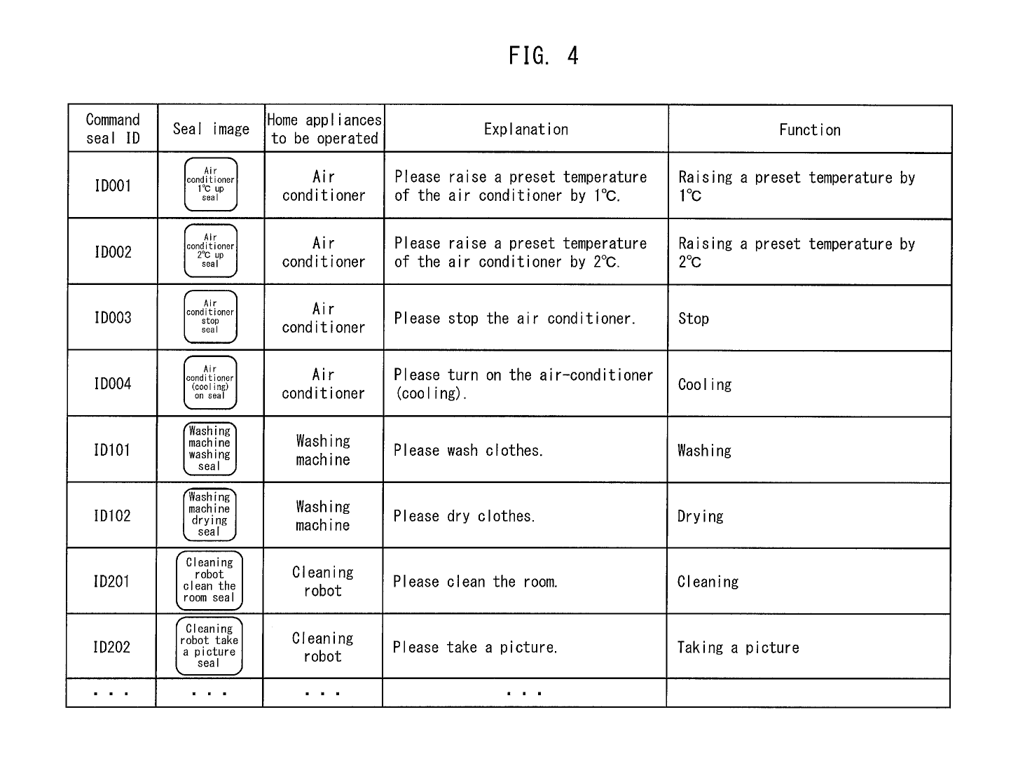

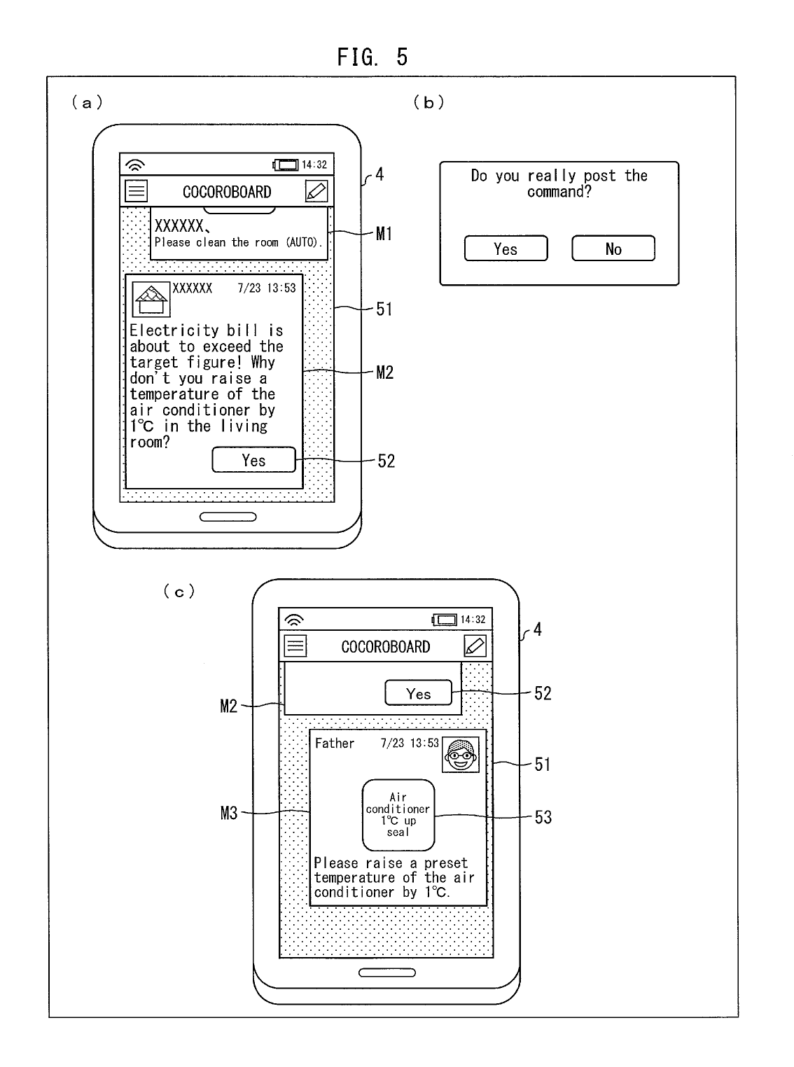

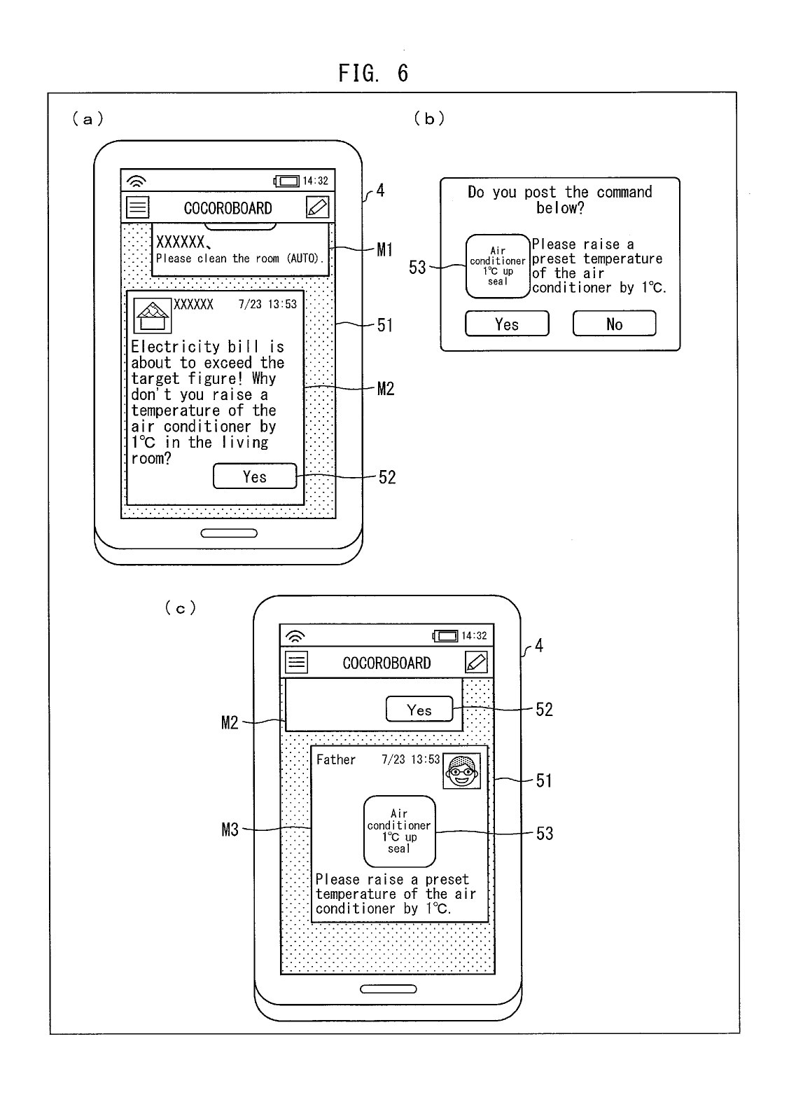

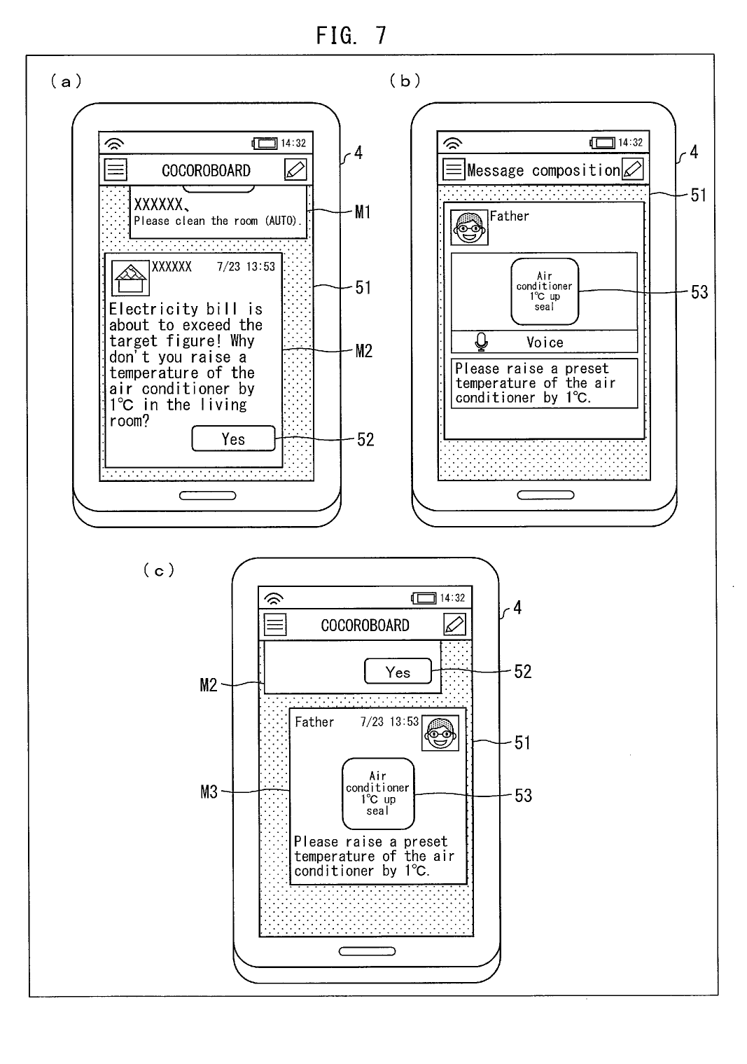

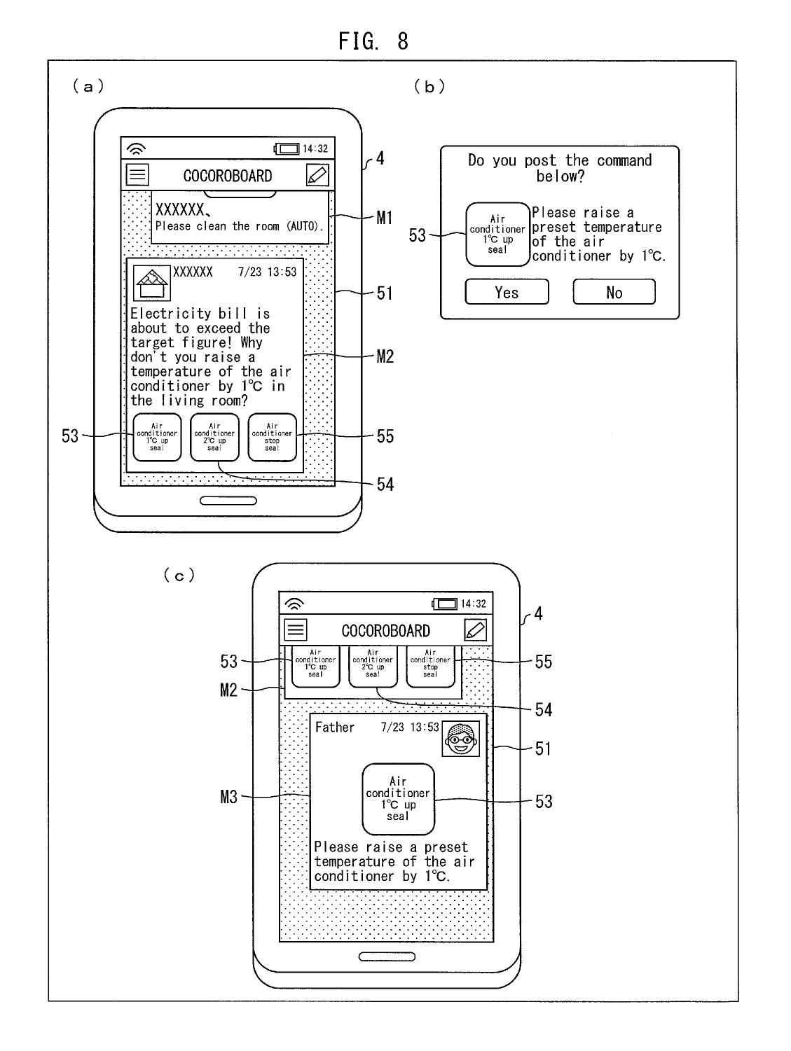

FIG. 4 is a view showing a specific example of the seal list table 41 stored in the storage section 11. In the seal list table 41, seal images (hereinafter, referred to as “command seals”), home appliances to be operated, explanation, and functions which are associated with the command seal IDs from the message list table 40 are stored.

The seal is preferably recognized uniquely by the command seal ID. The command seal is designed to show a particular function. The command seal is displayed as an operation button on a screen illustrated in, for example, (c) of FIG. 5. On this screen, not only the command seal, but also explanation (please raise a preset temperature of the air conditioner by 1° C.) associated with the command seal is displayed.

In this way, only by seeing the command seal, the user can understand intuitively that a target home appliance is the air conditioner, what function can be executed, and whether or not to execute the functions.

(Function Configuration of Family Message-Board Server 2)

In the agent server 1 of this embodiment, posting for managing function operations is carried out not by the user but by the device such as the home server 3, the cleaning robot 5, the home device 9, or other devices. Therefore, the device (e.g., Mr. Hems) posts a comment on the family message-board server 2 as a person who posted a comment, and the user checks the content of the comment with use of the portable terminal 4.

The posting receiving section 30 of the control section 12 of the family message-board server 2 receives not only posting from the user's portable terminal 4, but also posting from the agent server 1 serving as a personified device (Mr. Hems or the like). The comment received by the posting receiving section 30 is added to the family message board, and the users belonging to the identical community can browse the family message board via their portable terminals 4.

Further, the posting receiving section 30 receives not only posting from the agent server 1 but also posting by the user from the portable terminal 4. In this embodiment, posting by the user is posting of the seal associated with the above command seal ID.

In a case where a command seal is posted from the user's portable terminal 4, the posting receiving section 30 determines that the home device operation instruction is posted, and supplies the command seal thus posted to the command communication section 31.

The command communication section 31 communicates, on the basis of the command seal ID of the command seal thus posted, the operation instruction of the device to the function execution instruction section 24 of the agent server 1.

For example, in a case where a seal having a command seal ID “ID001” is posted, the function execution instruction section 24 refers to the seal list table 41, and instructs the home server 3 to execute a function of raising, by 1° C., the preset temperature of the air conditioner (air conditioner 6) which is a target home appliance associated with the ID001.

The following description will discuss writing on the family message board by the agent server 1.

(Outline of Family Message Board)

The message composed by the message composing section 22 is transmitted to the family message-board server via the screen generation section 23 and the communication section (not shown). The family message-board server 2 writes, on the family message board, the message received from the agent server 1.

In the family message-board system 100 according to this embodiment, a response message to the message written by a member on the family message board is also written on the family message board. Therefore, the family message-board system 100 and the members can communicate with each other.

(Personification of Device)

The agent server 1 writes a message as a personified character (Mr. Hems) which is a personified device of the home server 3. Specifically, the agent server 1 causes the family message-board server 2 to write a message on the family message board as if Mr. Hems writes the message. More specifically, a symbol for reminding the users of Mr. Hems is attached to the message. For example, in a case where an icon of Mr. Hems serving as a symbol of the home server 3 is used as an icon of a message that the agent server 1 causes the family message-board server 2 to write on the family message board, a person who posted the message seems to be the home server 3. The symbol includes, in addition to the icon, display reminding a user of a particular home appliance (in this example, home server 3) such as images, moving images, and combinations of letters. Thus, the agent server 1 can transmit a message as if the home server 3 writes the message on the family message-board server 2.

In the above description, the configuration in which the home server 3 and the cleaning robot 5 are personified has been described, however, home appliances other than the home server 3 and the cleaning robot 5 can commodities may be personified.

(Posting on Family Message Board)

The following description will discuss a posting process on the family message board with reference to FIG. 5. (a) and (c) of FIG. 5 are views illustrating display examples of a display screen 51 which displays messages in the form of time line on the family message board of the portable terminal 4. (b) of FIG. 5 is a view illustrating a check dialog when an operation button 52 in (a) of FIG. 5, which means “Yes”, is selected.

The agent server 1 composes a message in accordance with the sensor information generated by the sensor (not shown) which is provided in the house, the operation information on the home device 9, which is generated by the home device 9, and the like, and posts the message thus composed on the family message board. At this time, posting of the message by the agent server 1 on the family message board is carried out as if a character (Mr. Hems) which is a personified home server 3 is a person who posted the message. This makes it possible that the family members can experience communication simulatively with Mr. Hems on the family message board.

On the family message board, posted messages M1 to M3 are displayed in the form of time line as illustrated in, for example, (a) and (c) of FIG. 5. The messages written by the members are displayed in the order from top to bottom (in the order in which the messages are written) on the family message board, and, in each message, an icon indicating who posted a message is displayed.

For example, the posted message M2 displayed on the display screen 51 of the portable terminal 4 illustrated in (a) of FIG. 5 is posted by Mr. Hems, so that the message from Mr. Hems is written. This message has been extracted by the message composing section 22 on the basis of the conditions (1) and (2) and the person who posted a comment of the message list table 40. In the posted message M2, the operation button 52 meaning “Yes” is displayed as a link message associated with the message. The operation button 52 meaning “Yes” of the link message is associated with the command seal ID “ID001”, so that, in a case where the operation button 52 meaning “Yes” is selected (via a touch operation), an execution instruction of a function of the device, which function corresponds to the command seal ID, is transmitted. After that, a message indicating that the execution instruction has been carried out is displayed as a posted message M3 on the display screen 51 of the portable terminal 4 illustrated in (c) of FIG. 5. In the posted message M3, a command seal 53 corresponding to the command seal ID is displayed and explanation (FIG. 4) associated with the command seal is displayed.

Here, as described above that, immediately after a touch operation (hereinafter, referred to as “push”) for selecting the operation button 52 meaning “Yes” displayed on the display screen 51 illustrated in (a) of FIG. 5 is carried out, the posted message M3 including the command seal 53 may be displayed on the display screen 51 illustrated in (c) of FIG. 5. Alternatively, in a case where a user pushes the operation button 52 meaning “Yes” displayed on the display screen 51, the check dialog illustrated in (b) of FIG. 5 may be displayed to recheck the user about posting of the message. As described above, by putting the check dialog between messages, even if the operation button 52 meaning “Yes” is pushed accidentally, the message can be prevented from being posted immediately. For example, even if the operation button 52 meaning “Yes” is pushed accidentally during scrolling of the display screen 51, the message is not posted immediately, and, by selecting “No” in the check dialog, it is possible to prevent the function of the device from being executed due to an operating error execution.

The check dialog is displayed on the portable terminal 4 by the screen generation section 23 of the control section 10 of the agent server 1. That is, in a case where the screen generation section 23 receives an operation instruction in the operation button 52, the screen generation section 23 causes the check dialog to be displayed on the portable terminal 4, which check dialog allows a user to input permission to input the operation instruction for operating the device to be instructed.

As described above, according to the device-operation management apparatus of this embodiment, in a case where a user transmits an operation instruction (command) to a target home appliance, the user does not need to search out the command. Therefore, only by agreeing to a proposal from the agent server 1, the operation instruction is executed with respect to the device to be operated. This makes it possible to reduce time and effort for search outing and selecting a command seal (command) for causing the operation instruction to be executed with respect to the device in response to the proposal from the agent server 1.

Note that, in order to obtain the above effect, the agent server 1 (device-operation management apparatus) may be configured as below. That is, the device-operation management apparatus for receiving an operation instruction of a device from a terminal device via an input operation by a user and managing the operation of the device provided in a house, the device-operation management apparatus may be configured to include a message composing section 22 for composing a message indicating an operation proposal to the device (home device 9) provided in the house, wherein an operation setting used when a message whose content is the operation instruction (operation button 52) for operating the device in accordance with the operation proposal indicated by the message composed by the message composing means is set in input means (touch screen or the like) for receiving the input operation by the user from the terminal device 4.

With this configuration, the information which is provided in order that the message composing section 22 composes a message is not only information obtained from the information obtaining section 20 but also information provided by a user.

Further, in order to obtain the above effect, a method of controlling the device-operation management apparatus of the present invention only needs to be configured as follows. That is, the method for receiving an operation instruction of a device from a terminal device via an input operation by a user and managing the operation of the device provided in a house, the method includes the steps of: (A) composing a message indicating an operation proposal to the device provided in the house; and (B) setting, in input means (touch screen or the like) for receiving the input operation by the user from the terminal device 4, an operation setting used when a message whose content is the operation button 52 for operating the device in accordance with the operation proposal indicated by the message composed in the step (A).

Note that, in a case where a personified agent such as Mr. Hems is used to post a message, the information obtaining section 20 is essential.

### Embodiment 2

The following description will discuss another embodiment of the present invention. Note that, for the sake of easy explanation, members and configurations having the like functions as the figures described in Embodiment 1 are denoted by the like reference signs and the detailed description thereof is omitted.

(a) and (c) of FIG. 6 are views illustrating display examples of the display screen 51 which displays the posted messages M1 to M3 in the form of time line on the family message board of the portable terminal 4. (b) of FIG. 6 is a view illustrating a check dialog when the operation button 52 meaning “Yes” illustrated in (a) of FIG. 6 is selected.

The check dialog of this embodiment is different from that illustrated in (b) of FIG. 5 in Embodiment 1 in that, as illustrated in (b) of FIG. 6, the command seal 53 associated with the operation button 52 meaning “Yes” illustrated in (a) of FIG. 6 and explanation are displayed in the check dialog.

The check dialog is displayed on the portable terminal 4 by the screen generation section 23 of the control section 10 of the agent server 1. That is, the screen generation section 23 displays, in the check dialog of the portable terminal 4, the command seal 53 which is an image associated with the command for use in the operation of the device.

As described above, by displaying the command seal 53 and the explanation thereof in the check dialog, the user can easily determine, only by reading the check dialog, whether or not the message should be posted.

### Embodiment 3

The following description will discuss another embodiment of the present invention. Note that, for the sake of easy explanation, members and configurations having the like functions as the figures described in the above Embodiments are denoted by the like reference signs and the detailed description thereof is omitted.

(a) and (c) of FIG. 7 are views illustrating display examples of the display screen 51 which displays the posted messages M1 to M3 in the form of time line on the family message board of the portable terminal 4. (b) of FIG. 7 is a view illustrating a posting input (message composing) screen displayed when the operation button 52 meaning “Yes” illustrated in (a) of FIG. 7 is selected.

This embodiment is different from Embodiments 1, 2 in that the check dialog is not putted between the messages, and, as illustrated in (b) of FIG. 7, a posting screen is displayed on the display screen 51.

On the posting input screen illustrated in (b) of FIG. 7, the command seal 53 and the explanation, which correspond to the operation button 52 meaning “Yes” illustrated in (a) of FIG. 7, are displayed. In a case where a content of this posted message displayed on the posting input screen has no problem, the user pushes a transmission button to post the message, meanwhile, in a case where the content has any problem, the user edits the message and then posts it.

The posting input screen is displayed on the portable terminal 4 by the screen generation section 23 of the control section 10 of the agent server 1. That is, on a touch screen of the portable terminal 4, when the operation button 52 is set, the screen generation section 23 causes the portable terminal 4 to display the input screen (posting input screen) for editing a content of an operation instruction for causing a device to execute the operation, which operation instruction is included in the operation button 52.

As described above, by putting not only the check dialog but also the posting input screen between messages, the user can take an appropriate measure not only when the user confirms that the message has no problem, but also when the user confirms that the message has a problem. This makes it possible to improve convenience for the user.

### Embodiment 4

The following description will discuss another embodiment of the present invention. Note that, for the sake of easy explanation, members and configurations having the like functions as the figures described in the above Embodiments are denoted by the like reference signs and the detailed description thereof is omitted.

(a) and (c) of FIG. 8 are views illustrating display examples of the display screen 51 which displays the posted messages M1 to M3 in the form of time line on the family message board of the portable terminal 4. (b) of FIG. 8 is a view illustrating, among a plurality of buttons illustrated in (a) of FIG. 8, a check dialog including a pushed button.

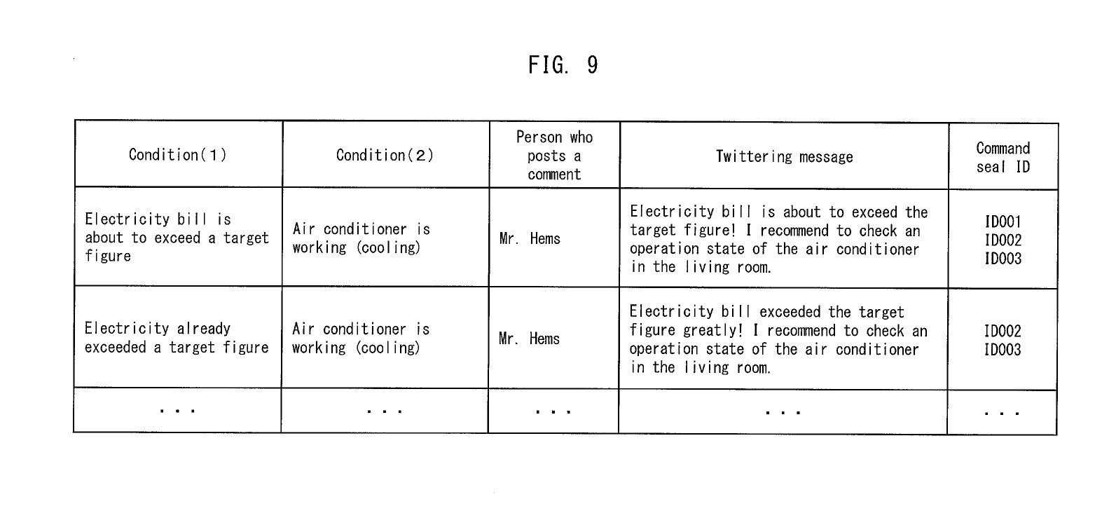

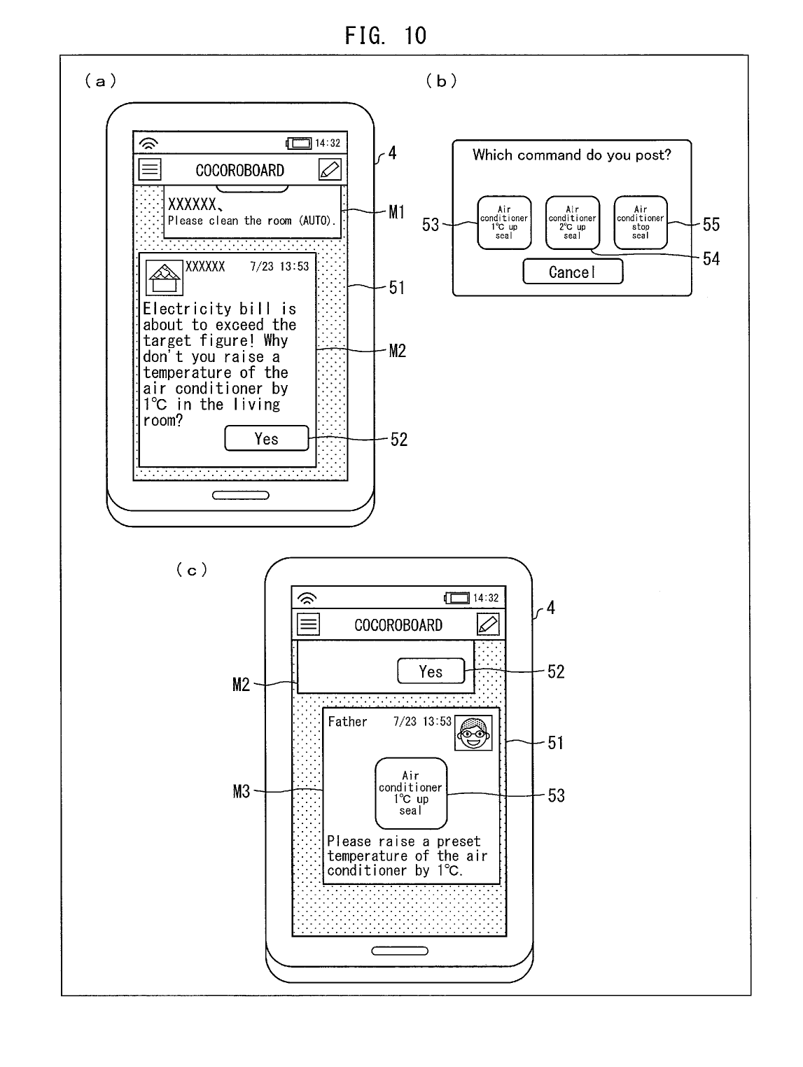

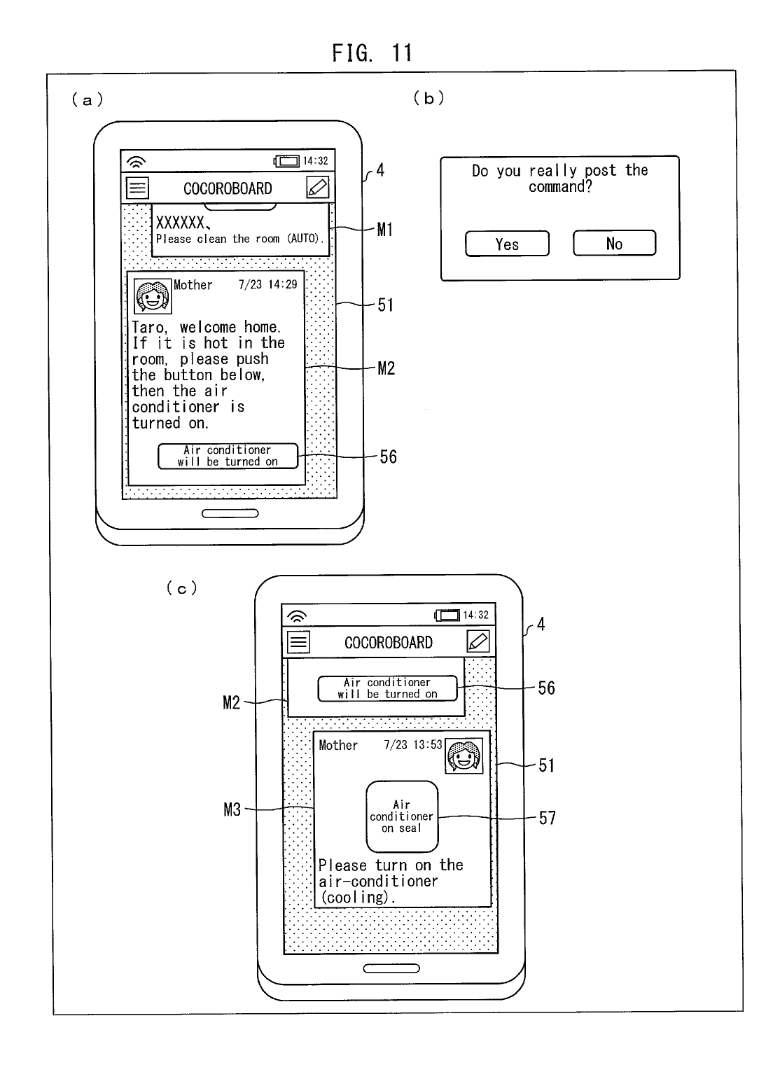

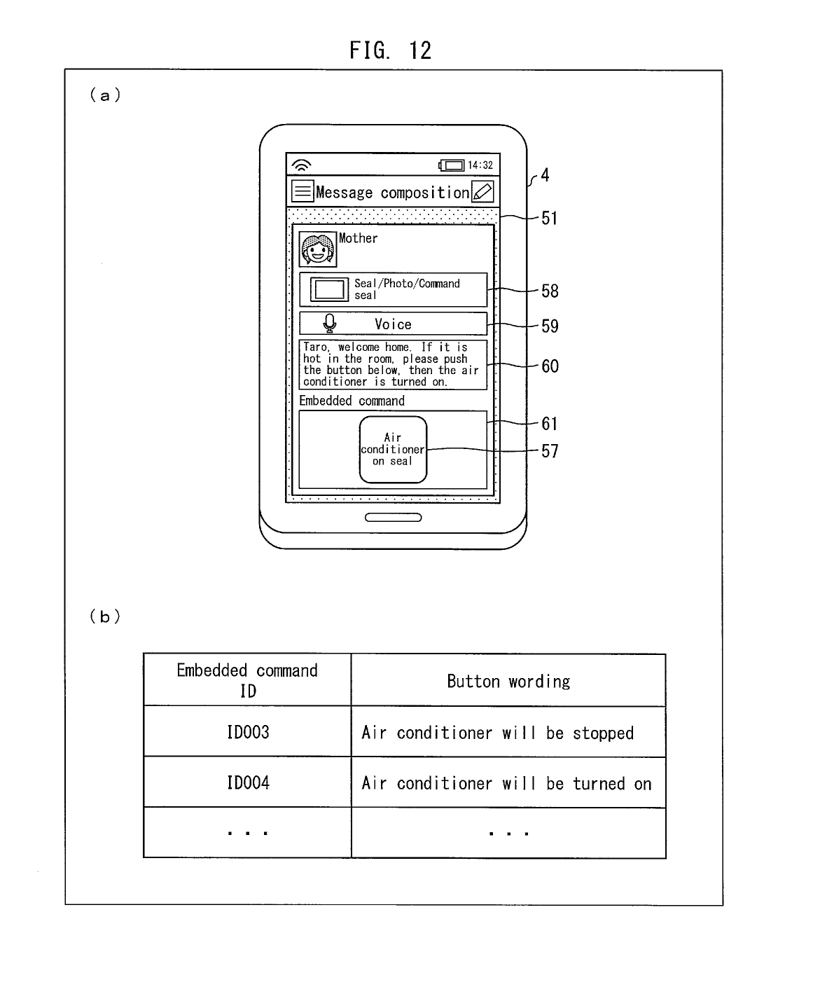

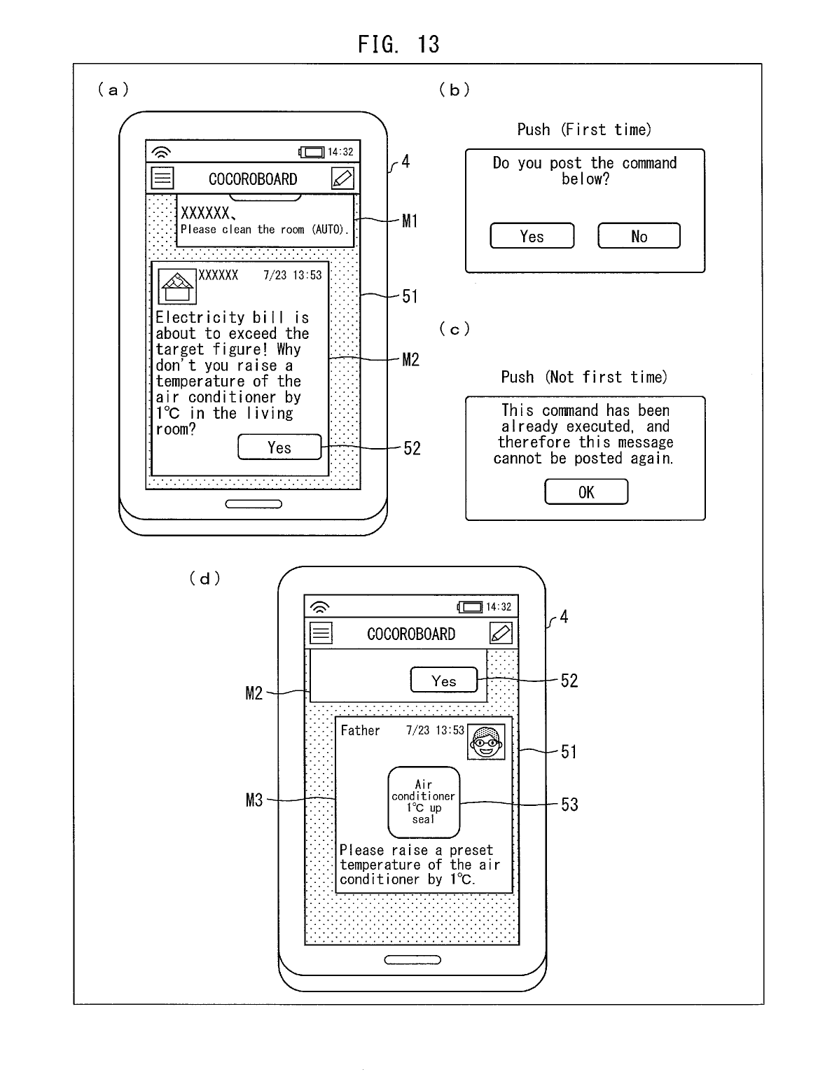

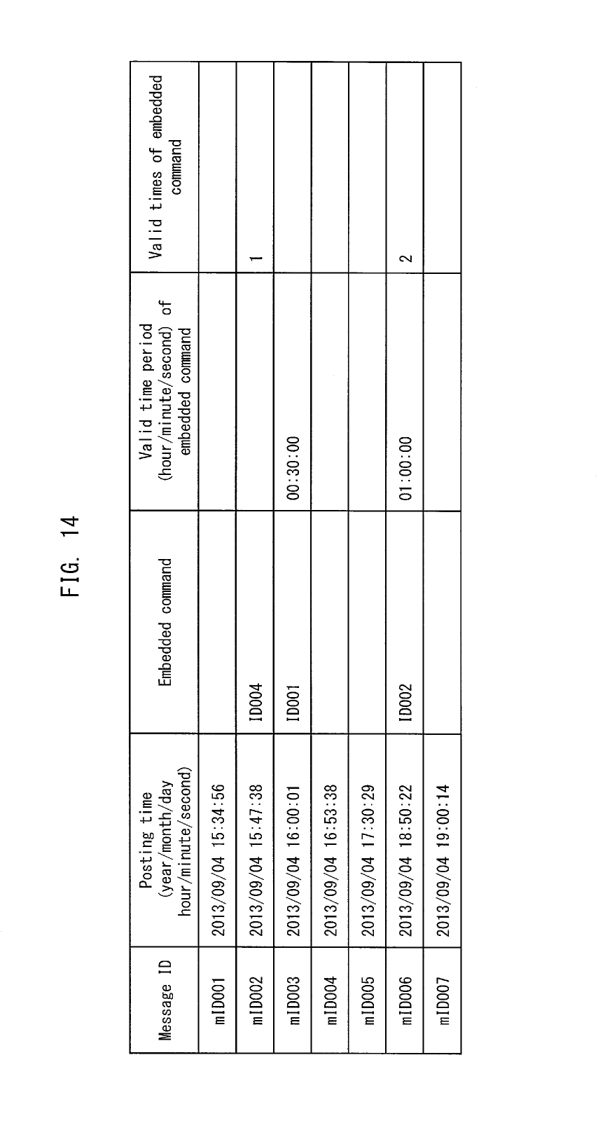

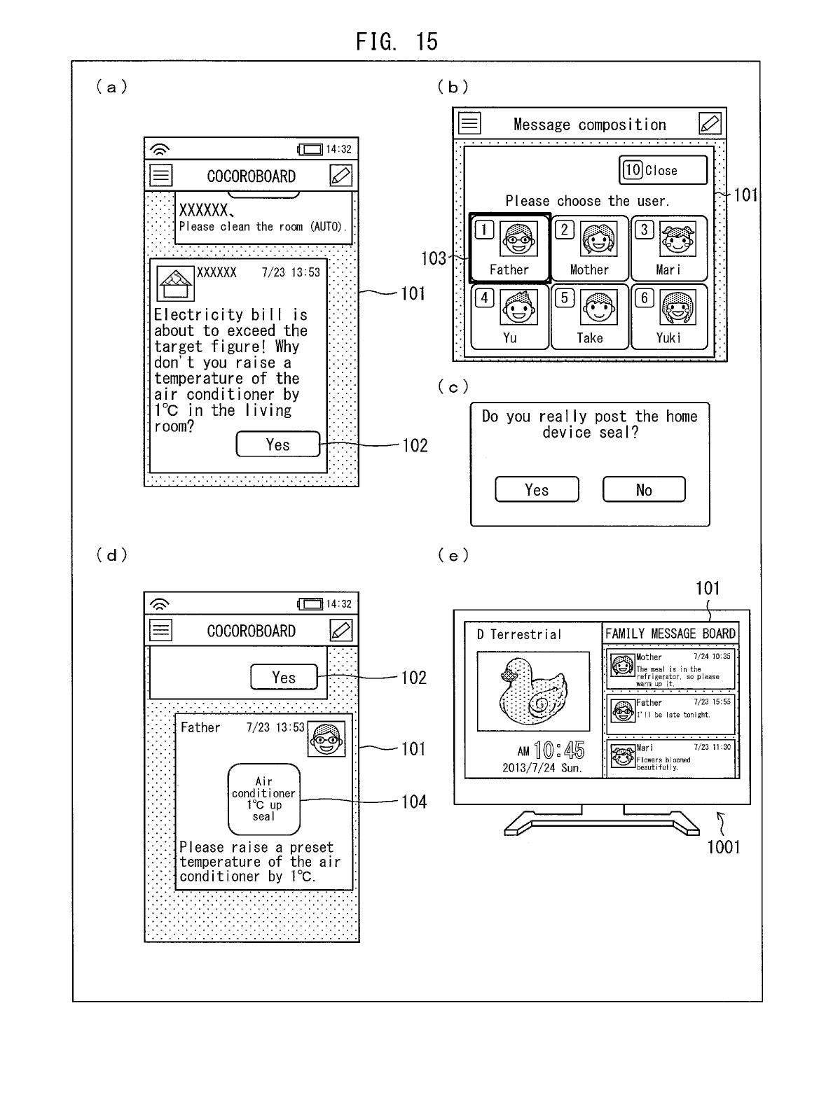

FIG. 9 is another example of the message list table 40 for use in this embodiment.

This embodiment is different from Embodiments 1 to 3 in that, as a posted message from the agent server 1, command seals 53, 54, 55 indicating candidate commands are displayed together with a twittering message of Mr. Hems. That is, in this embodiment, multiple kinds of command seals (command seals 53, 54, 55) corresponding to commands for causing the device to perform operations are displayed as operation buttons in the posted message M2 posted by Mr. Hems. Those command seals (respective images) explicitly represent corresponding command contents, respectively, and are displayed to be selected alternatively. That is, the command seal 53 corresponds to an instruction to raise a temperature of an air conditioner by 1° C., the command seal 54 corresponds to an instruction to raise the temperature of the air conditioner by 2° C., and the command seal 55 corresponds to an instruction to stop the air conditioner, and those command seals are displayed to be selected alternatively. To put it another way, the user can read the contents of the command seals and select any one of the command seals. Note that the multiple kinds of command seals may be four or more.

Here, in order to present multiple seals in a single posted message, as illustrated in, for example, FIG. 9, a pair of the conditions (1) and (2), a person who posted a comment, and a twittering message may be associated with multiple command seal IDs. In FIG. 9, the condition (1): a case where an electricity bill exceeds a target figure, the condition (2): an air conditioner (cooling) is being operated, the person who posted a comment: Mr. Hems, the twittering message: “Electricity bill is about to exceed the target figure! I recommend to check an operation state of the air conditioner in the living room.” correspond to three command seal IDs (ID001 (air conditioner 1° C. up seal), ID002 (air conditioner 2° C. up seal), and ID003 (air conditioner stop seal)).

Among the three command seals, (b) of FIG. 8 illustrates a check dialog in a case where the command seal 53 is selected. Processes thereafter are carried out in the same way as the above Embodiment.

As described above, the user can select a command by displaying the multiple command seals corresponding to the message posted by the agent server 1. This makes it possible to transmit, to the device, an instruction that the user desires.

### Embodiment 5

The following description will discuss another embodiment of the present invention. Note that, for the sake of easy explanation, members and configurations having the like functions as the figures described in the above Embodiments are denoted by the like reference signs and the detailed description thereof is omitted.

(a) and (c) of FIG. 10 are views illustrating display examples of the display screen 51 which displays the posted messages M1 to M3 in the form of time line on the family message board of the portable terminal 4. (b) of FIG. 10 is a view illustrating a check dialog displayed when the operation button 52 meaning “Yes” illustrated in (a) of FIG. 10 is pushed.

This embodiment is different from Embodiment 4 in that, instead of displaying the command seals 53, 54, 55 indicating the candidate commands together with the twittering message of Mr. Hems as the message posted by the agent server 1, the command seals 53, 54, 55 indicating the candidate commands are displayed in the check dialog as illustrated in (b) of FIG. 10.

(c) of FIG. 10 displays the posted message M3 on the display screen 51 in a case where the command seal 53 is selected.

The check dialog is displayed on the portable terminal 4 by the screen generation section 23 of the control section 10 of the agent server 1. Specifically, the screen generation section 23 causes multiple kinds of command seals (in this embodiment, the three command seals 53, 54, and 55), which correspond to the commands for causing the device to execute operations, to be displayed on the check dialog of the portable terminal 4. Those command seals (images) explicitly represent contents of the commands, respectively, and are displayed to be selected alternatively. That is, the command seal 53 corresponds to an instruction to raise a temperature of an air conditioner by 1° C., the command seal 54 corresponds to an instruction to raise the temperature of the air conditioner by 2° C., and the command seal 55 corresponds to an instruction to stop the air conditioner, and those command seals are displayed to be selected alternatively. To put it another way, the user can read the contents of the command seals and select any one of the command seals. Note that the multiple kinds of command seals may be four or more.

As described above, in a case where the commands can be selected in the check dialog, the user can select a command in the same way as Embodiment 4, so that it is possible to transmit an instruction that the user desires to the device.

### Embodiment 6

The following description will discuss another embodiment of the present invention. Note that, for the sake of easy explanation, members and configurations having the like functions as the figures described in the above Embodiments are denoted by the like reference signs and the detailed description thereof is omitted.

(a) and (c) of FIG. 11 are views illustrating display examples of the display screen 51 which displays the posted messages M1 to M3 in the form of time line on the family message board of the portable terminal 4. (b) of FIG. 11 is a view illustrating a check dialog when the operation button 52 meaning “Yes” illustrated in (a) of FIG. 11 is pushed.

(a) of FIG. 12 illustrates an input screen for posting a message, and (b) of FIG. 12 shows a button wording correspondence table.

This embodiment is different from Embodiments 1 to 5 in that a person who posted a comment is not a personified character such as Mr. Hems as the agent server 1, and will discuss an example where, in response to a message posted by an actual user (here, mother), another family member posts a message. To put it another way, a message is not composed by the message composing section 22 of the agent server 1 but in the portable terminal 4 that the user directly operate. Note that a flow of processes after the message is composed is substantially the same as those in the above Embodiments.

In a case where the user composes a message, as illustrated in (a) of FIG. 11, an operation button 56 indicating that “the air conditioner will be turned on” is displayed, instead of the operation button 52 meaning “Yes”, in the message posted by mother. In a case where the operation button 56 indicating that “air conditioner will be turned on” is pushed, a check dialog illustrated in (b) of FIG. 11 is displayed. In a case where there is no problem, “Yes” is pushed, and an instruction to turn on the air conditioner is posted. Then, as illustrated in (c) of FIG. 11, a posted message to which an air conditioner (cooling) on seal 57 is attached is displayed on the display screen 51.

In order to make a posting screen illustrated in (a) of FIG. 11, the user uses a posting input screen represented by the display screen 51 illustrated in (a) of FIG. 12 in the portable terminal 4. The posting input screen includes a first selection display column 58, a voice input column 59, a text input column 60, and a second selection display column 61.

The user inputs a message with use of the voice input column 59 or the text input column 60 on the posting input screen. The message thus inputted is displayed on the text input column 60. The user selects, from the first selection display column 58, (i) an illustration (seal), (ii) a photograph for expressing feeling of a person who posted the message, or (iii) a desired seal, photograph, or command seal in order to cause the device to execute an operation. A selected one is displayed in the first selection display column 58. Further, in order to embed, in a message, an operation instruction for causing the device to execute the operation, the user selects a desired command seal from the second selection display column 61. The selected seal is displayed in the second selection display column 61.

A command is embedded in a displayed seal, and the command is associated with wording written in a button (button wording) which is displayed on the posting screen as illustrated in (b) of FIG. 12.

A correspondence table between the command and the button wording is stored as the button wording correspondence table 42 in the storage section 11 of the agent server 1 illustrated in FIG. 1.

In a case where the operation button 56 indicating that “the air conditioner will be turned on” on the posting screen illustrated in (a) of FIG. 11 is put, the check dialog illustrated in (b) of FIG. 11 is displayed, and further, when “Yes” is pushed, the message illustrated in (c) of FIG. 11 is posted.

In a case where the message illustrated in (c) of FIG. 11 is posted, the posting receiving section 30 of the family message-board server 2 transmits the command, which is attached to the posted message thus received and is associated with the air conditioner (cooling) on seal 57, to the command communication section 31, and the command is transmitted via the command communication section 31 to the function execution instruction section 24. The function execution instruction section 24 transmits, to the home server 3, an instruction to execute a corresponding function with reference to the command thus transmitted and the seal list table 41 of the storage section 11.

As described above, even in a case where a message is inputted by a user, another user who reads the message thus posted does not need to search out an operation command of a desired device, and only needs to push a button attached to the message, which is similar to a case where a message is posted by the personified device 9. Therefore, it is possible to reduce work and effort to operate the device.

### Embodiment 7

The following description will discuss another embodiment of the present invention. Note that, for the sake of easy explanation, members and configurations having the like functions as the figures described in the above Embodiments are denoted by the like reference signs and the detailed description thereof is omitted.

For example, the operation button 52 meaning “Yes” attached on the posting screen in the device-operation management apparatus described in Embodiments 1 to 6 is not limited by the number of times of receiving the operation instruction, specifically, the number of times of touch operation (hereinafter, referred to as “the number of times of pushing”), or is not limited by various conditions such as a time limit of touch operation (push). This is because posted messages are sequentially displayed chronologically on a time line in general, so that there is no possibility that, when an operation of pushing “Yes” displayed in a posted message is carried out once, the operation is never pushed again. However, in a case where multiple users read an identical posted message simultaneously or with a slight time difference, there is a possibility that the operation button 52 meaning “Yes” is pushed two or more times. Therefore, it is necessary to invalidate the operation button 52 meaning “Yes”.

In view of the circumstances, in this embodiment, the following description will discuss a device-operation management apparatus which achieves invalidation of the operation button 52 meaning “Yes” by controlling the number of times of pushing the operation button 52 meaning “Yes” attached to the posted message or a time period within which the operation button 52 can be pushed.

(Case of Controlling the Number of Times of Pushing Operation Button 52 Meaning “Yes”)

(a) and (d) of FIG. 13 are views illustrating display examples of the display screen 51 which displays the posted messages M1 to M3 in the form of time line on the family message board of the portable terminal 4. (b) and (c) of FIG. 13 are views each illustrating a check dialog when the operation button 52 meaning “Yes” illustrated in (a) of FIG. 13 is pushed.

For example, in a case where the number of times of pushing the operation button 52 meaning “Yes” included in the posted message illustrated in (a) of FIG. 13 is once, i.e., the operation button 52 is pushed first, the check dialog (same as the check dialog of (b) of FIG. 5 in Embodiment 1) illustrated in (b) of FIG. 13 is displayed. Meanwhile, in a case where the number of times of pushing the operation button 52 meaning “Yes” is twice or more, a check dialog illustrated in (c) of FIG. 13 is displayed. A message indicating that “this command has been already executed, and therefore this message cannot be posted.” is displayed in the check dialog illustrated in (c) of FIG. 13, and this posting is not performed even if the operation button 52 meaning “Yes” is pushed.

The above example has discussed a case where the number of times of pushing the operation button 52 meaning “Yes” is limited to once, however, the number of times of pushing the operation button 52 meaning “Yes” may be limited to multiple times. For example, in a case where the number of times of pushing the operation button 52 meaning “Yes” is set to three times, the message illustrated in (c) of FIG. 13 is changed to a message indicating that “the number of pushing times of this command exceeds the limit, and therefore this message cannot be posted.” when the number of times of pushing the operation button 52 becomes four or more times.

Specifically, in a case where the number of times of touch operation of the operation button 52 becomes larger than the predetermined number of times, the control section 10 (invalidation means) invalidates the touch operation of the operation button 52, and causes the message, which indicates that the operation button 52 is invalidated, to be displayed as the check dialog as described above.

Further, the operation button 52 meaning “Yes” is limited not only by the number of times but also by a time period.

(Case of Limiting Times of Pushing Operation Button 52 Meaning “Yes”)

For example, in a case where the time period within which the operation button 52 meaning “Yes” can be pushed is set to 30 minutes or less after a message to which the operation button 52 meaning “Yes” is attached as illustrated in (a) of FIG. 13 is posted, the message of (c) of FIG. 13 is changed to a message indicating that “a valid time period of this command has been expired, and therefore this message cannot be posted.” when the operation button 52 meaning “Yes” is pushed after 30 minutes have passed.

Specifically, when a predetermined time period has been passed since the operation button 52 was displayed (since the operation setting was set in the input means (was displayed on the touch screen)), the control section 10 (invalidation means) invalidates a touch operation of the operation button 52, and causes the check dialog, which indicates that the operation button 52 has been invalidated, to be displayed as described above.

FIG. 14 is a view showing a table for achieving invalidation of the operation button 52 meaning “Yes”. The table is stored as the button invalidation table 43 in the storage section 11 of the agent server 1 illustrated in FIG. 1. To put it another way, whether or not the operation button 52 is invalidated is determined by the control section 10 with reference to the table.

Contents of the button invalidation table 43 will be described as below.

The message IDs are IDs uniquely assigned for all messages posted on the time line.

A posting time indicates a time at which the message is posted on the timeline.

An embedded command indicates an ID of a seal (command) embedded in a message posted by a family or a home appliance. Note that, in a case where this column is not provided, there is no embedded command in the message (e.g., a case where a posted message includes only regular text+illustration).

A valid time period of this embedded command indicates a valid time period which has passed since the message was posted. For example, a message ID mID003 indicates that ID001 is valid for 30 minutes only and that a command corresponding to ID001 can be executed until it becomes 4:30:01 PM on Sep. 4, 2013.

The valid times of an embedded command indicates the valid times of the embedded command. For example, mID002 indicates that ID004 becomes active once, so that the ID004 is invalidated when ID004 is pushed twice or more times.

In a case where both a valid time period of the embedded command and the valid times of the embedded command are controlled, it is necessary to satisfy the both. For example, in a case of mID006, it is not possible to post the same message three times or more within an hour and it is not possible to post the message when one hour has passed even if the message has been never posted.

Note that, the valid time period of this embedded command or the valid times of the embedded command may be determined in advance in association with the ID of the embedded command, or, in a case where, for example, a family member posts a message, the family member may set the time period and the number of times on the input screen.

As described above, by setting the valid time period of the embedded command or the valid times of the embedded command, it is possible to reduce an unnecessary message caused by pushing the operation button 52 meaning “Yes”.

### Embodiment 8

The following description will discuss another embodiment of the present invention. Note that, for the sake of easy explanation, members and configurations having the like functions as the figures described in the above Embodiments are denoted by the like reference signs and the detailed description thereof is omitted.

(a) to (e) of FIG. 15 are views illustrating an example where the device-operation management apparatus of the present invention is applied to a TV having a network function.

In a case where the device-operation management apparatus is applied to a TV, as illustrated in (e) of FIG. 15, a posting screen 101 is displayed in a part of a display region of a TV main body 1001, and a user checks a posted message on the posting screen 101.

(a), (c), and (d) of FIG. 15 correspond to (a), (b), and (c) of FIG. 5 of Embodiment 1, respectively. This embodiment is different from Embodiment 1 in that, in a case where a button 102 indicating “Yes”, which is attached to the posted message on the posting screen 101 illustrated in (a) of FIG. 15, is pushed, it is necessary to select who transmits this message on a transmitter selection screen illustrated in (b) of FIG. 15. After the transmitter is selected, a check dialog illustrated in (c) of FIG. 15 is displayed, the message is posted, and a posting screen on which a seal 104 illustrated in (d) of FIG. 15 is attached is displayed.

### Embodiment 9

Control blocks of the agent server 1 (particularly, the analyzing section 21, the message composing section 22, and the screen generation section 23 of the control section 10) may be realized by a logic circuit (hardware) provided in an integrated circuit (IC chip) or the like or may be realized by software as executed by a CPU (Central Processing Unit).

In the latter case, the agent server 1 includes: a CPU that executes instructions of a control program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

Note that Embodiments describe examples where the portable terminal 4 is used as a device (posting means) that a user uses to post a message, however, for example, a television, a personal computer, and a game device which are connected to a network can be used as the posting means.

[Summary]

A device-operation management apparatus according to an aspect 1 of the present invention, which is for receiving an operation instruction of a device from a terminal device (portable terminal 4) via an input operation by a user and managing the operation of the device (home device 9) provided in a house, the device-operation management apparatus (agent server 1) includes message composing means (message composing section 22) for composing a message indicating an operation proposal to the device (home device 9) provided in the house, wherein an operation setting (operation button 52) used when a message whose content is the operation instruction for operating the device in accordance with the operation proposal indicated by the message composed by the message composing means (message composing section 22) is set in input means (touch screen) for receiving the input operation by the user from the terminal device (portable terminal 4).

According to the configuration, the operation setting (operation button 52) used when a message whose content is the operation instruction for operating the device in accordance with the operation proposal indicated by the message composed by the message composing section 22 is set in the input means (touch screen) for receiving the input operation by the user from the terminal device (portable terminal 4). Therefore, the user can cause the device to execute the operation in response to the operation instruction only by operating (touch operation, push operation) the operation button (52). To put it another way, it is unnecessary to search out the operation instruction for operating the device, i.e., a command. This makes it possible to reduce time and effort of a user when the user transmits a command for operating a home appliance.

The device-operation management apparatus of an aspect 2 in accordance with the aspect 1 of the present invention may further include information obtaining section (20) for obtaining at least one of sensor information generated by a sensor provided in the house and operation information on the device (9) provided in the house, which operation information is generated by the device, wherein, from a result of analysis of the at least one of the sensor information and the operation information that the information obtaining section (20) obtained, the message composing section (22) composes the message indicating the operation proposal to the device (9) provided in the house.

According to the configuration, the message is composed by the message composing section (22) from the result of analysis of the at least one of the sensor information generated by the sensor provided in the house and the operation information on the device, which operation information is generated by the device (9) provided in the house, so that the message is automatically composed when the information is obtained, and is displayed on the portable terminal (4).

Therefore, a user can reduce time and effort to obtain various kinds of information and then compose a message.

The device-operation management apparatus according to an aspect 3 in accordance with the aspect 1 or 2 of the present invention may further include display control means (screen generation section 23) for causing a check dialog to be displayed on the terminal device (portable terminal 4) in a case where the operation setting (operation button 52) is set in the input means, the check dialog allowing a user to input permission to input the operation instruction for operating the device to be instructed, which instruction is included in the operation setting.

According to the configuration, in a case where the input means receives the operation setting (operation button 52), the check dialog, which allows the user to input the permission to input the operation instruction for operating the device to be instructed, which instruction is included in the operation setting, is displayed on the terminal device (portable terminal 4). Therefore, it is possible to prevent the message from being posted due to an operating error of the operation button (52).

To put it another way, by displaying the check dialog, even if the operation button (52) is accidentally pushed, it is possible to prevent the message from being immediately posted.

In the device-operation management apparatus according to an aspect 4 in accordance with the aspect 3 of the present invention, the display control means (screen generation section 23) may display, in the check dialog, an image (command seal 53) associated with a command for use in the operation of the device.

According to the configuration, in a case where the command seal (53) and explanation thereof is displayed in the check dialog, the user can easily determine whether or not to post the message only by reading the check dialog.

The device-operation management apparatus according to an aspect 5 in accordance with the aspect 1 or 2 of the present invention may further include display control means (screen generation section 23) for causing an input screen to be displayed on the terminal device (portable terminal 4) in a case where the operation setting (operation button 52) is set in the input means, the input screen being for editing the content of the operation instruction for operating the device to be instructed, which instruction is included in the operation setting.

According to the configuration, by putting, instead of the check dialog, the input screen for editing the operation instruction for operating the device between messages a user can edit the content of the operation instruction in a case where the operation instruction has a problem. This makes it possible to improve convenience for the user.

In the device-operation management apparatus according to an aspect 6 in accordance with the aspect 1 or 2 of the present invention, the input means may display, on the terminal device (portable terminal 4), operation buttons for receiving input operations from the user in accordance with the operation setting; the operation buttons are multiple kinds of images (command seals 53) corresponding to respective commands for causing the device to execute operations; and the multiple kinds of images (command seals 53) may represent respective contents of the commands explicitly and may be displayed to be selected alternatively.

According to the configuration, by displaying the multiple command seals in response to a message posted by the agent server 1, the user can select a command, so that it is possible to transmit an instruction that the user desires to the device.

In the device-operation management apparatus according to an aspect 7 in accordance with the aspect 3 of the present invention, the display control means (screen generation section 23) may display (i) multiple kinds of images (command seal 53) corresponding to respective commands for causing the device to execute operations and (ii) contents of the multiple kinds of images in the check dialog so that the multiple images can be selected alternatively.

According to the configuration, by configuring the check dialog so as to display commands so that a user can select one, the user can select a command. Therefore, it is possible to transmit an instruction that the user desires to the device, as well as Embodiment 4.

The device-operation management apparatus according to an aspect 8 in accordance with any one of the aspects 1 to 7 of the present invention may further include invalidation means (control section 10) for invalidating reception of the operation instruction in the input means when the number of times of receiving the operation instruction in the operation setting (operation button 52) set in the input means exceeds a predetermined number of times.

The device-operation management apparatus according to an aspect 9 in accordance with any one of the aspects 1 to 7 of the present invention may further include invalidation means (control section 10) for invalidating reception of the operation instruction in the input means when a predetermined period of time has passed since the operation setting (operation button 52) was set in the input means.

According to the configuration, by setting the valid time period of the embedded command (operation button 52) or the valid times of the embedded command (operation button 52), it is possible to reduce posting of unnecessary messages due to unnecessary pushing of the operation button 52 meaning “Yes”.

A remote operation system according to an aspect 10 according to the present invention includes: a device-operation management apparatus (agent server 1) as recited in any one of the aspects 1 to 9; and a message board device for managing an electronic message board (family message board) which can be used by at least one terminal device (portable terminal 4), wherein: in a case where a message is posted on the electronic message board (family message board) via the terminal device (portable terminal 4), the message board device (family message-board server 2) notifies an instruction of a device (home device 9) to the device-operation management apparatus (agent server 1), which instruction is associated with the message thus posted; and the device-operation management apparatus (agent server 1) transmits a command to the device to be instructed so as to cause the device (family message-board server 2) to execute a function operation thus notified.

According to the configuration, the user operating a device via the message thus posted can reduce time and effort to search out the command, so that it is possible to achieve a remote operation system having excellent operability.

A method of controlling a device-operation management apparatus according to an aspect 11 of the present invention, which is for receiving an operation instruction of a device (home device 9) from a terminal device (portable terminal 4) via an input operation by a user and managing the operation of the device provided in a house, the method includes the steps of: (A) composing a message indicating an operation proposal to the device provided in the house; and (B) setting, in input means for receiving the input operation by the user from the terminal device, an operation setting used when a message whose content is the operation instruction for operating the device (home device 9) in accordance with the operation proposal indicated by the message composed in the step (A).

The method of controlling the device-operation management apparatus having the above configuration has the same effect as the device-operation management apparatus of the aspect 1.

The device-operation management apparatus according to the foregoing aspects of the present invention may be realized by a computer. In this case, the present invention encompasses: a control program for the device-operation management apparatus which program causes a computer to operate as the foregoing means of the device-operation management apparatus so that the device-operation management apparatus can be realized by the computer; and a computer-readable storage medium storing the control program therein.

The present invention is not limited to the description of the embodiments above, and can be modified in numerous ways by a skilled person as long as such modification falls within the scope of the claims. An embodiment derived from a proper combination of technical means disclosed in different embodiments is also encompassed in the technical scope of the present invention.

### INDUSTRIAL APPLICABILITY

The present invention can be favorably used particularly in a remote operation system which needs to remotely operate a controlled device.

### REFERENCE SIGNS LIST

1 agent server (device-operation management apparatus)
2 family message-board server (message board device)
3 home server
4 portable terminal (terminal device)
5 cleaning robot
6 air conditioner
7 illumination device
8 ion generator
9 home device
10 control section
11 storage section
12 control section
20 information obtaining section (information obtaining means)
21 analyzing section
22 message composing section (message composing means)
23 screen generation section (display control means)
24 function execution instruction section
30 posting receiving section
31 command communication section
40 message list table
41 seal list table
42 button wording correspondence table
43 button invalidation table
51 display screen
52 operation button
53 command seal
54 command seal
55 command seal
56 operation button
57 air conditioner cooling on seal
58 first selection display column
59 voice input column
60 text input column
61 second selection display column
100 family message-board system
101 screen
102 button
104 seal
1001 TV main body
M1 posted message
M2 posted message
M3 posted message

1. A device-operation management apparatus for receiving an operation instruction of a device from a terminal device via an input operation by a user and managing the operation of the device provided in a house,
the device-operation management apparatus comprising
message composing means for composing a message indicating an operation proposal to the device provided in the house,
wherein an operation setting used when a message whose content is the operation instruction for operating the device in accordance with the operation proposal indicated by the message composed by the message composing means is set in input means for receiving the input operation by the user from the terminal device.

2. The device-operation management apparatus as set forth in claim 1, further comprising
information obtaining means for obtaining at least one of sensor information generated by a sensor provided in the house and operation information on the device provided in the house, which operation information is generated by the device,
wherein, from a result of analysis of the at least one of the sensor information and the operation information that the information obtaining means obtained, the message composing means composes the message indicating the operation proposal to the device provided in the house.

3. The device-operation management apparatus as set forth in claim 1, further comprising
display control means for causing a check dialog to be displayed on the terminal device in a case where the operation setting is set in the input means, the check dialog allowing a user to input permission to input the operation instruction for operating the device to be instructed, which instruction is included in the operation setting.

4. The device-operation management apparatus as set forth in claim 2, further comprising
display control means for causing a check dialog to be displayed on the terminal device in a case where the operation setting is set in the input means, the check dialog allowing a user to input permission to input the operation instruction for operating the device to be instructed, which instruction is included in the operation setting.

5. The device-operation management apparatus as set forth in claim 3,
wherein the display control means displays, in the check dialog, an image associated with a command for use in the operation of the device.

6. The device-operation management apparatus as set forth in claim 4,
wherein the display control means displays, in the check dialog, an image associated with a command for use in the operation of the device.

7. The device-operation management apparatus as set forth in claim 1, further comprising
display control means for causing an input screen to be displayed on the terminal device in a case where the operation setting is set in the input means, the input screen being for editing the content of the operation instruction for operating the device to be instructed, which instruction is included in the operation setting.

8. The device-operation management apparatus as set forth in claim 2, further comprising
display control means for causing an input screen to be displayed on the terminal device in a case where the operation setting is set in the input means, the input screen being for editing the content of the operation instruction for operating the device to be instructed, which instruction is included in the operation setting.

9. The device-operation management apparatus as set forth in claim 1, wherein:
the input means displays, on the terminal device, operation buttons for receiving input operations from the user in accordance with the operation setting;
the operation buttons are multiple kinds of images corresponding to respective commands for causing the device to execute operations; and
the multiple kinds of images represent respective contents of the commands explicitly and are displayed to be selected alternatively.

10. The device-operation management apparatus as set forth in claim 2, wherein:
the input means displays, on the terminal device, operation buttons for receiving input operations from the user in accordance with the operation setting;
the operation buttons are multiple kinds of images corresponding to respective commands for causing the device to execute operations; and
the multiple kinds of images represent respective contents of the commands explicitly and are displayed to be selected alternatively.

11. The device-operation management apparatus as set forth in claim 3,
wherein the display control means displays (i) multiple kinds of images corresponding to respective commands for causing the device to execute operations and (ii) contents of the multiple kinds of images in the check dialog so that the multiple images can be selected alternatively.

12. The device-operation management apparatus as set forth in claim 4,
wherein the display control means displays (i) multiple kinds of images corresponding to respective commands for causing the device to execute operations and (ii) contents of the multiple kinds of images in the check dialog so that the multiple images can be selected alternatively.

13. The device-operation management apparatus as set forth in claim 1, further comprising
invalidation means for invalidating reception of the operation instruction in the input means when the number of times of receiving the operation instruction in the operation setting set in the input means exceeds a predetermined number of times.

14. The device-operation management apparatus as set forth in claim 2, further comprising
invalidation means for invalidating reception of the operation instruction in the input means when the number of times of receiving the operation instruction in the operation setting set in the input means exceeds a predetermined number of times.

15. The device-operation management apparatus as set forth in claim 1, further comprising
invalidation means for invalidating reception of the operation instruction in the input means when a predetermined period of time has passed since the operation setting was set in the input means.

16. The device-operation management apparatus as set forth in claim 2, further comprising
invalidation means for invalidating reception of the operation instruction in the input means when a predetermined period of time has passed since the operation setting was set in the input means.

17. A remote operation system, comprising:
a device-operation management apparatus for receiving an operation instruction of a device from a terminal device via an input operation by a user and managing the operation of the device provided in a house, the device-operation management apparatus comprising message composing means for composing a message indicating an operation proposal to the device provided in the house, wherein an operation setting used when a message whose content is the operation instruction for operating the device in accordance with the operation proposal indicated by the message composed by the message composing means is set in input means for receiving the input operation by the user from the terminal device;
a message board device for managing an electronic message board which can be used by at least one terminal device, wherein:
in a case where a message is posted on the electronic message board via the terminal device, the message board device notifies an instruction of a device to the device-operation management apparatus, which instruction is associated with the message thus posted; and
the device-operation management apparatus transmits a command to the device to be instructed so as to cause the device to execute a function operation thus notified.

18. The remote operation system as set forth in claim 17, further comprising
information obtaining means for obtaining at least one of sensor information generated by a sensor provided in the house and operation information on the device provided in the house, which operation information is generated by the device,
wherein, from a result of analysis of the at least one of the sensor information and the operation information that the information obtaining means obtained, the message composing means composes the message indicating the operation proposal to the device provided in the house.

19. A method of controlling a device-operation management apparatus for receiving an operation instruction of a device from a terminal device via an input operation by a user and managing the operation of the device provided in a house,
the method comprising the steps of:
(A) composing a message indicating an operation proposal to the device provided in the house; and
(B) setting, in input means for receiving the input operation by the user from the terminal device, an operation setting used when a message whose content is the operation instruction for operating the device in accordance with the operation proposal indicated by the message composed in the step (A).

20. A computer-readable storage medium storing a program for causing a computer to execute each step included in the method as recited in claim 19.
